(19) United States
(12) Patent Application Publication
(10) Pub. No.: US 2009/0295771 A1
(43) Pub. Date: Dec. 3, 2009

(54) PLASMA DISPLAY DEVICE AND DRIVING METHOD THEREOF

(76) Inventor: Suki Kim, Suwon-si (KR)

Correspondence Address: CHRISTIE, PARKER & HALE, LLP, PO BOX 7068, PASADENA, CA, 91109-7068, US

(21) Appl. No.: 12/472,314

(22) Filed: May 26, 2009

(30) Foreign Application Priority Data
May 27, 2008 (KR) 10-2008-0049043

(51) Int. Cl. G06F 3/038

(52) U.S. Cl. 345/210; 345/60

(57) ABSTRACT

A plasma display device and a driving method thereof for reducing an internal potential and a temperature of a scan integrated circuit (IC) and reduce manufacturing costs. The plasma display device includes: a scan electrode, a sustain electrode, a scan IC electrically coupled to the scan electrode; a first switch electrically coupled between the scan IC and a first voltage source; a second switching switch electrically coupled between the scan IC and a second voltage source; a third voltage source electrically coupled between the first and second switches to supply a third voltage; and a third switch electrically and serially coupled to the third voltage source between the first and second switches.

### CROSS-REFERENCE TO RELATED APPLICATION

This application claims priority to and the benefit of Korean Patent Application No. 10-2008-0049043, filed on May 27, 2008, in the Korean Intellectual Property Office (KIPO), the entire content of which is incorporated herein by reference.

### BACKGROUND OF THE INVENTION

1. Field of the Invention

The present invention relates to a plasma display device and a driving method thereof, and more particularly, to a plasma display device and a driving method thereof that can reduce an internal potential and a temperature of a scan integrated circuit (IC) and reduce manufacturing costs.

2. Description of the Related Art

A plasma display device displays images by discharge, and can realize digital images on a relatively large screen as compared to other display devices.

Generally, a scan IC is connected to a scan electrode of the plasma display device. The scan IC includes high and low level switches. However, in the plasma display device, current intensively flows through only one of the high and low level switches during most periods.

Such current channeling increases a temperature of the high or low level switch. As a result, the temperature of the scan IC is increased. In addition, the manufacturing costs are increased because an internal potential of the high or low level switch is increased.

On the other hand, a sustain current of the plasma display device is transmitted to a panel through the switch of the scan IC. However, an output waveform may be deformed by resistance and inductance of the switch when current passes through the high or low level switch.

### SUMMARY OF THE INVENTION

Aspects of embodiments of the present invention are directed toward a plasma display device and a driving method thereof that can reduce an internal potential and a temperature of a scan IC and reduce manufacturing costs.

An embodiment of the present invention provides a plasma display device including a scan electrode and a sustain electrode, The plasma display device includes: a scan IC electrically coupled to the scan electrode; a first switch electrically coupled between the scan IC and a first voltage source; a second switching switch electrically coupled between the scan IC and a second voltage source; a third voltage source electrically coupled between the first and second switches to supply a third voltage; and a third switch electrically and serially coupled to the third voltage source between the first and second switches.

The first voltage source may be the ground.

The third voltage source may be a direct current (DC) voltage source.

The third voltage source may include a capacitive element electrically coupled between the first and second switches and a DC-DC converter electrically coupled to both ends of the capacitive element.

The third voltage source may include a capacitive element electrically coupled between the first and second switches, a DC voltage source electrically coupled to one end of the capacitive element and a fourth switch electrically coupled between the capacitive element and DC voltage source.

An energy recovery unit may be electrically coupled to a contact point between the first switch or the second switch and the scan IC and include an inductive element and a capacitive element electrically coupled between the inductive element and the ground.

A fifth switch may be electrically coupled between the inductive element and the capacitive element.

The plasma display device may further include a harness wire having one end connected between the inductive element and capacitive element and the other end electrically coupled to the sustain electrode.

In addition, the inductive element and capacitive element of the energy recovery unit may be connected to each other in a back-to-back form.

The scan IC may include a high level switch electrically coupled between the scan electrode and first switch and a low level switch electrically coupled between the scan electrode and second switch.

The high and low level switches may be turned off while a positive voltage is applied to the scan electrode during a sustain period of the plasma display device, thereby allowing sustain current to flow through a body diode of the high level switch or the low level switch.

In addition, the high and low level switches may be turned off while a rising waveform of the plasma display device or the voltage of the second voltage source is applied to the sustain electrode during the sustain period, thereby allowing the sustain current to flow through the body diode of the high level switch or the low level switch.

In addition, the high level switch may be turned on and the low level switch may be turned off while a falling waveform is applied to the scan electrode during the sustain period, thereby allowing the sustain current to flow through the high level switch.

A sixth switch may be electrically coupled in parallel to the both ends of the scan IC.

In addition, the low level switch may be turned off while a falling waveform is applied to the scan electrode during the sustain period, thereby allowing the sustain current to be distributed and flow through the body diode of the low level switch.

Another embodiment of the present invention provides a method of driving a plasma display device including a scan electrode and a sustain electrode. The method includes: (a) applying a rising waveform to the scan electrode by turning on a fourth switch to allow sustain current to flow from an energy recovery unit through a body diode of a low level switch during a sustain period; and (b) applying a second voltage to the scan electrode by turning on a second switch to allow the sustain current to flow from a second voltage source through a body diode of a high level switch during the sustain period, where the plasma display device includes: a scan IC electrically coupled to the scan electrode; a first switch electrically coupled between the scan IC and a first voltage source; the second switch electrically coupled between the scan IC and the second voltage source; a third switch provided between the first switch and the energy recovery unit; the fourth switch provided between the second switch and the energy recovery unit, and where the scan IC includes the high level switch electrically coupled between the scan electrode and first switch and the low level switch electrically coupled between the scan electrode and second switch.

The method of driving the plasma display device may further include (c) applying a falling waveform to the scan electrode by turning on the third switch to allow the sustain current to flow through the body diode of the high level switch and (d) applying a first voltage to the scan electrode by turning on the first switch to allow the sustain current to flow through the body diode of the high level switch after the step (b).

The first voltage source may supply the ground voltage.

The second voltage source may supply a sustain voltage.

The energy recovery unit may include an inductive element electrically coupled to the third switch and a capacitive element electrically coupled to the inductive element, and may be electrically coupled to the sustain electrode through a harness wire electrically coupled between the inductive element and capacitive element, thereby charging and discharging energy applied to the scan and sustain electrodes.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic view illustrating a plasma display device according to one exemplary embodiment of the present invention;

FIG. 2 is a schematic view illustrating a driving circuit used in the plasma display device of FIG. 1;

FIG. 3 is a drive timing diagram of the plasma display device;

FIG. 4 is a schematic view illustrating current flow during a reset period of the plasma display device of FIG. 1;

FIG. 5 is a schematic view illustrating current flow during an address period of the plasma display device of FIG. 1;

FIGS. 6 and 7 are schematic views illustrating current flow during a sustain period of the plasma display device of FIG. 1;

FIG. 8 is a schematic view illustrating a driving circuit used in a plasma display device according to another exemplary embodiment of the present invention;

FIG. 9 is a schematic view illustrating a driving circuit used in a plasma display device according to another exemplary embodiment of the present invention; and

FIG. 10 is a schematic view illustrating a driving circuit used in a plasma display device according to another exemplary embodiment of the present invention.

### DETAILED DESCRIPTION OF EXEMPLARY EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

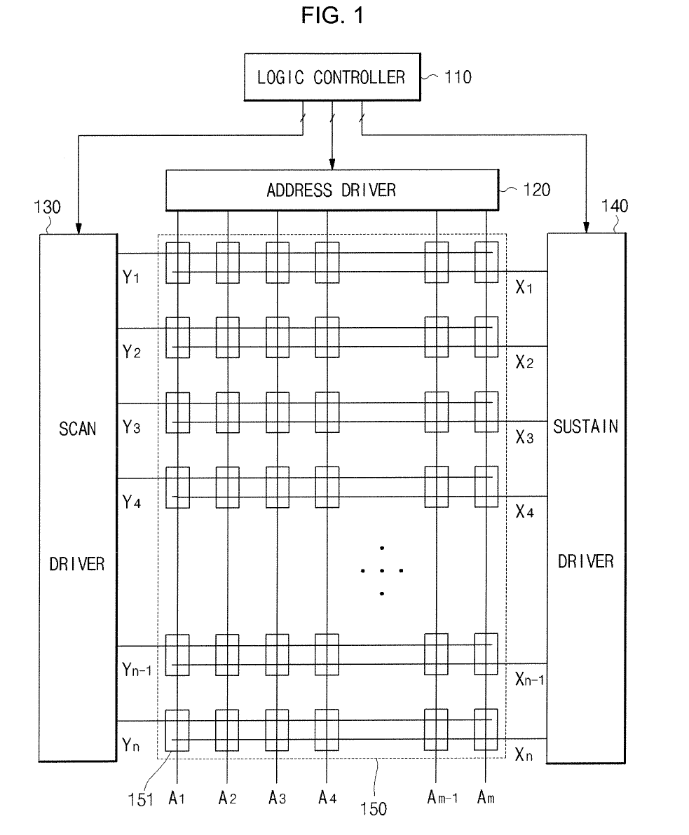

FIG. 1 shows a schematic view illustrating a plasma display device according to one exemplary embodiment of the present invention.

Referring to FIG. 1, the plasma display device includes a logic controller 110, an address driver 120, a scan driver 130, a sustain driver 140 and a display panel (or display region) 150.

The logic controller 110 converts an image signal transmitted from an image processor or an external device into a data signal that can be processed by the drivers 120, 130 and 140. In addition, the logic controller 110 controls each driver by transmitting data and a control signal to each driver 120,130 and 140.

The address driver 120 receives the data and control signal from the logic controller 110 and supplies an address signal to an address electrode (A: A1 to Am). Here, in one embodiment, a discharge cell 151 that perform display discharge is selected by the address signal from the address driver 120, or, in another embodiment, a discharge cell 151 that does not perform display discharge is selected by the address signal from the address driver 120. That is, in one embodiment, when a selective writing method is used, the discharge cell selected in an address period performs display discharge. By contrast, in another embodiment, when a selective erasing method is used, the discharge cell that is not selected performs display discharge.

The scan driver 130 receives the data and control signal from the logic controller 110 and supplies reset, scan and sustain signals to a scan electrode (Y: Y1 to Yn).

The scan driver 130 supplies a rising ramp pulse that rises gradually, and a falling ramp pulse that falls gradually during a reset period. The scan driver 130 is synchronized with the address signal during the address period to supply a scan pulse. In addition, the scan driver 130 supplies a sustain signal during a sustain period.

The sustain driver 140 supplies the sustain signal to the display panel 150 according to the data and control signal from the logic controller 110. Here, it is explained that the sustain signal is supplied by the scan driver 130 and sustain driver 140. In another embodiment, the sustain signal may be supplied only by the scan driver 130. When the sustain signal is supplied only by the scan driver 130, the sustain driver 140 may be integrated with the scan driver 130.

The display panel 150 displays an image by a driving signal supplied by the address driver 120, scan driver 130 and sustain driver 140. To display the image, the address electrode (A), scan electrode (Y) and sustain electrode (X) are formed in the display panel 150. The address driver 120 is provided at one side of the display panel 150. The address driver 120 and address electrode (A) are connected to each other by a connection member, particularly, a tape carrier package. The address electrode (A) is formed to extend in a first direction on the display panel 150. The scan electrode (Y) and sustain electrode (X) are formed to extend in a second direction crossing (or orthogonal to) the first direction of the address electrode (A) on the display panel 150.

In addition, the scan electrode (Y) and sustain electrode (X) are also respectively connected to the scan driver 130 and sustain driver 140 by the connection member. A discharge cell 151 is formed at a region where the address electrode (A), scan electrode (Y) and sustain electrode (x) cross (or intersect) each other.

A construction of a driving circuit used in the plasma display device will be explained below in more detail.

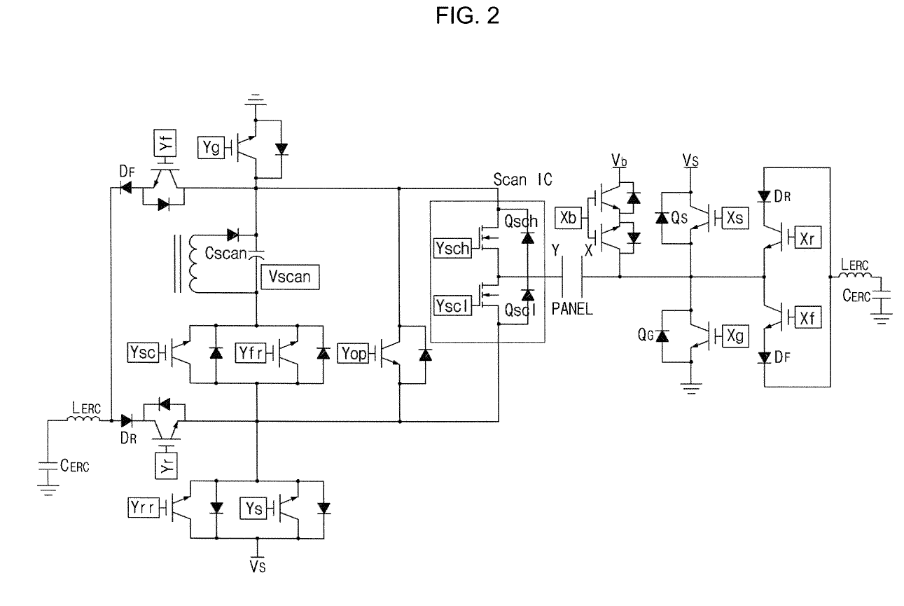

FIG. 2 shows the driving circuit used in the plasma display device.

Referring to FIG. 2, the driving circuit used in the plasma display device includes a Scan IC connected to the scan electrode (Y), a ground switch Yg connected between the Scan IC and ground, a rising ramp switch Yrr connected between the Scan IC and a sustain voltage source Vs, a scan voltage source Vscan connected between the ground switch Yg and rising ramp switch Yrr, and a falling ramp switch Yfr serially connected to the scan voltage source Vscan.

In addition, the driving circuit may further include a sustain switch Ys connected in parallel to the rising ramp switch Yrr, a scan switch Ysc connected in parallel to the falling ramp switch Yfr, and a bypass switch Yop connected in parallel to the Scan IC.

In addition, the driving circuit may further include an energy recovery circuit connected to the Scan IC, an energy recovery switch Yf, an energy recovery diode D_{F}, an energy supply switch Yr and an energy supply diode D_{R} that are connected between the Scan IC and energy recovery circuit.

The Scan IC includes a high level switch Ysch connected between the scan electrode (Y) and ground switch Yg and a low level switch Yscl connected between the scan electrode (Y) and rising ramp switch Yrr. The high level switch Ysch and low level switch Yscl have body diodes Qsch and Qscl respectively.

The ground switch Yg is connected between the ground and high level switch Ysch. In other words, the ground voltage can be supplied to the Scan IC through the ground switch Yg. The voltage(s) applied to the Scan IC is provided by two voltage sources such as high and low voltage sources in the conventional device. However, the driving circuit of FIG. 2 can simplify its power source by substituting the ground for the high level voltage source. As a result, manufacturing costs are reduced.

The scan voltage source Vscan is connected between the ground switch Yg and sustain switch Ys. The scan voltage source Vscan may be a DC voltage source. In addition, the scan voltage source Vscan may be formed of a capacitive element Cscan connected between the ground switch Yg and sustain switch Ys and a DC-DC converter connected to both ends of the capacitive element Cscan. Accordingly, the capacitive element Cscan stores the voltage applied by the DC-DC converter. As a result, the capacitive element Cscan can operate as a voltage source by keeping voltage of both ends thereof constant.

The energy recovery circuit includes an inductive element L_{ERC} connected to the ground switch Yg and a capacitive element C_{ERC} connected between the inductive element L_{ERC} and ground. The energy recovery circuit recovers energy by resonance of the inductive element L_{ERC} and capacitive element C_{ERC} and supplies the recovered energy. Thus, power supplied to the scan electrode (Y) during the sustain period can be reduced by the energy recovery circuit.

In addition, a bias voltage source Vb, the sustain voltage source Vs, inductive element L_{ERC}, capacitive element C_{ERC} and switches (Xb, Xs, Xg, Xr, Xf) for controlling supply of the voltages may be connected to the sustain electrode (X). These elements are suitably constructed as shown in FIG. 2.

As described above, in the driving circuit of the plasma display device, a sustain block (Yg, Ys, Yf, Yr) is located near the scan electrode (Y). Thus, sustain operation of the driving circuit can be efficiently performed.

In addition, the driving circuit of the plasma display device does not include a main pass switch and a diode that has been used in the conventional device, thereby reducing the manufacturing costs.

Operation of the driving circuit will be explained in more detail below.

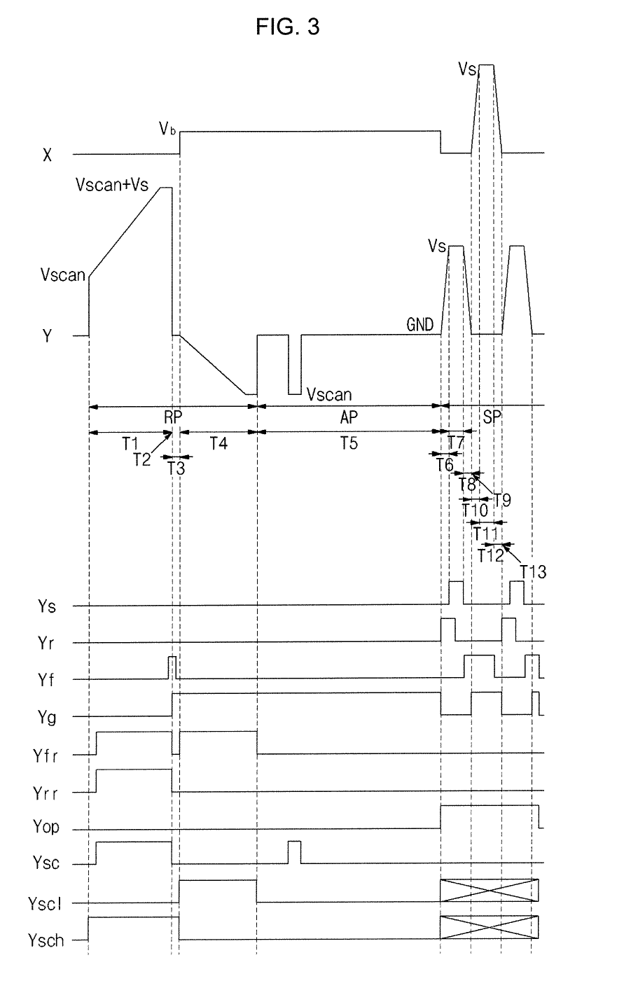

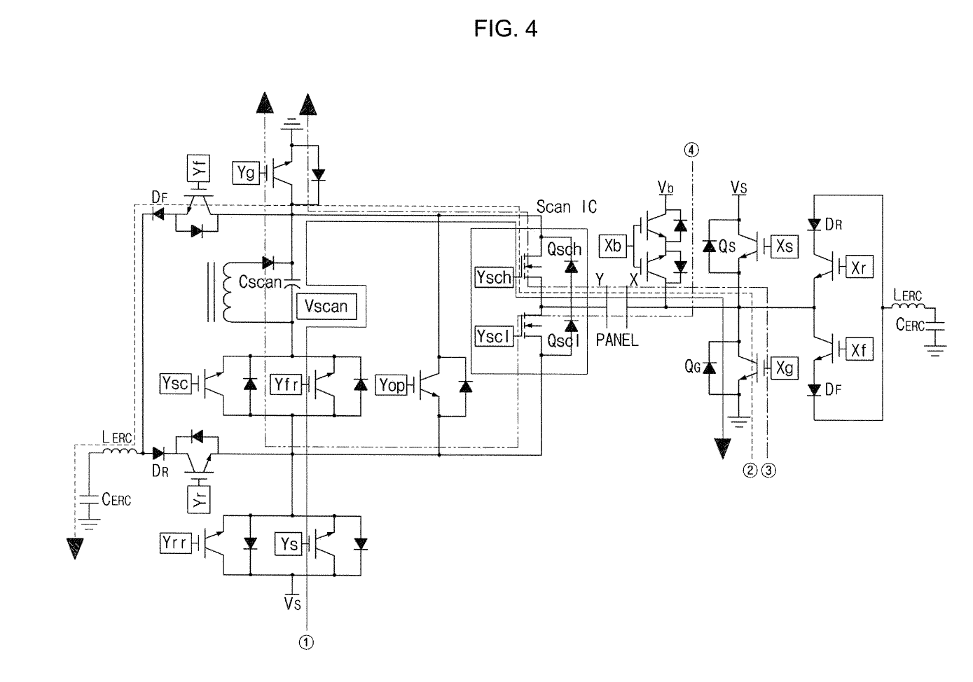

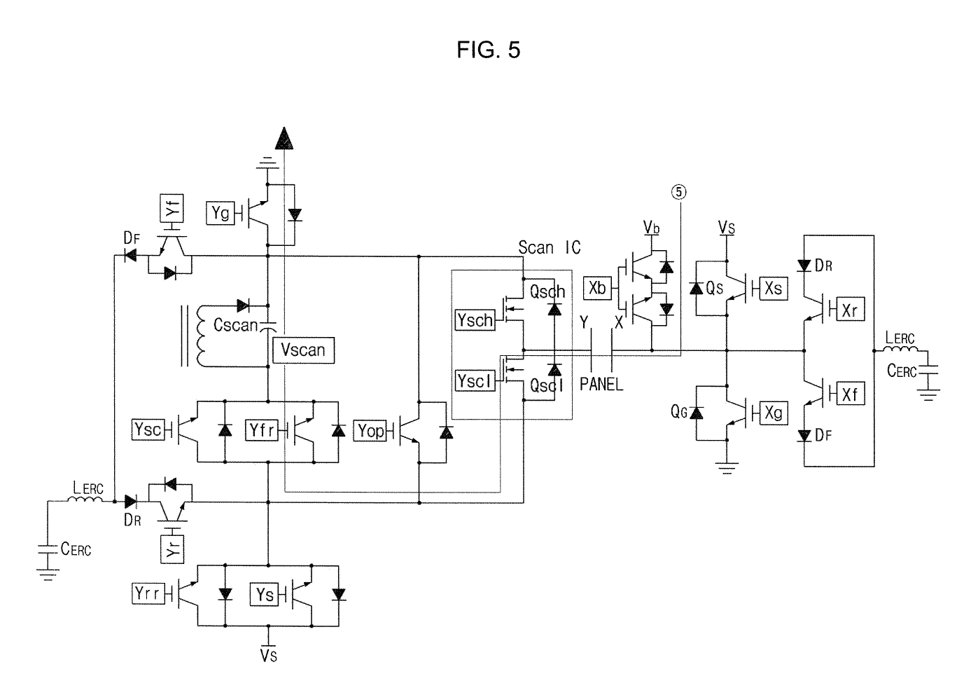

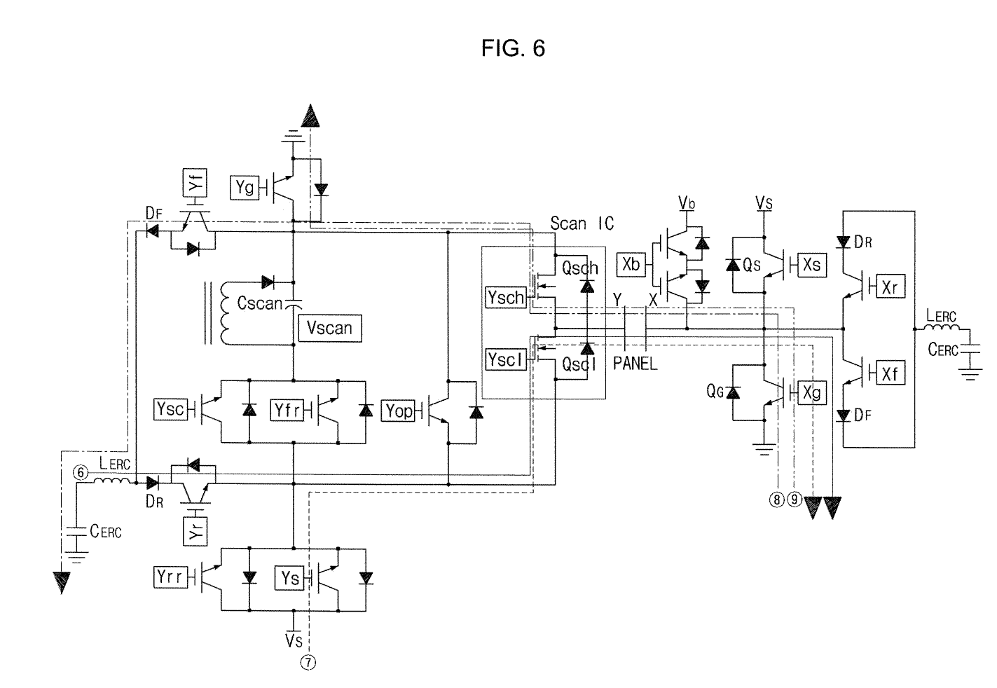

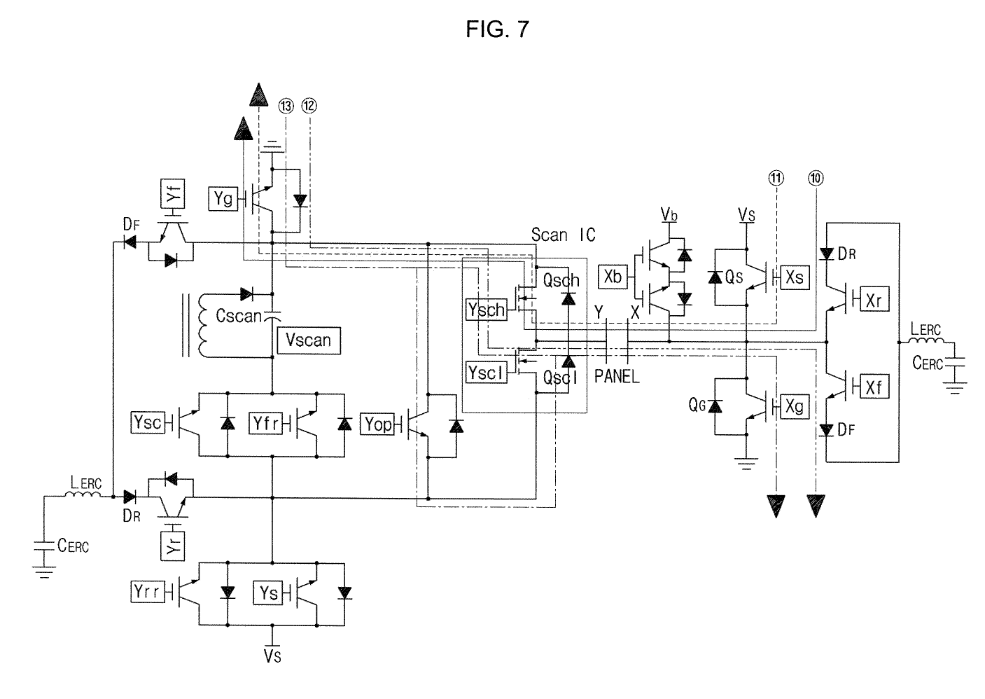

FIG. 3 shows a drive waveform diagram of the driving circuit used in the plasma display device. FIG. 4 is a schematic view illustrating current flow during a reset period of the plasma display device, FIG. 5 is a schematic view illustrating current flow during an address period of the plasma display device, and FIGS. 6 and 7 are schematic views illustrating current flow during a sustain period of the plasma display device.

Referring to FIGS. 3 and 4, a rising ramp pulse and a falling ramp pulse are applied to the scan electrode (Y) during a reset period (RP) to initialize wall charges of the scan electrode (Y). The reset period (RP) may be further divided into T1 to T4 periods according to a waveform that is applied.

At the beginning of the period T1, the high level switch Ysch of the Scan IC is first turned on to provide margin. Then, the rising ramp switch Yrr, falling ramp switch Yfr and scan switch Ysc are turned on. Accordingly, a current path is formed along a path \textcircled{1} in FIG. 4, where the current path is formed through the sustain voltage source Vs, rising ramp switch Yrr, scan switch Ysc, falling ramp switch Yfr, scan voltage source Vscan and high level switch Ysch to the scan electrode (Y). Thus, a rising ramp waveform increasing as much as the sustain voltage source Vs is applied to the scan electrode (Y) according to the state that the rising ramp switch Yrr is turned on. In this time, the ground switch Xg is turned on, and a ground signal is applied to the sustain electrode (X).

During the T2 period, the high level switch Ysch is maintained to be turned on, and the energy recovery switch Yf is turned on. As a result, the energy recovery circuits (L_{ERC} and C_{ERC}) are connected to the scan electrode (Y) along a path \textcircled{2} in FIG. 4. Accordingly, potential of the scan electrode (Y) is gradually decreased. On the other hand, the sustain electrode (X) is connected to the ground through a body diode Q_{G} of the ground switch Xg to maintain the ground potential.

During the T3 period, the high level switch Ysch is maintained to be turned on, and the ground switch Yg is turned on. Accordingly, the scan electrode (Y) is connected to the ground along a path \textcircled{3} in FIG. 4. As a result, the potential of the scan electrode (Y) is kept in the ground potential. Also, similar to the T2 period, the sustain electrode (X) is connected to the ground through the body diode Q_{G} of the ground switch Xg to maintain the ground potential.

During the T4 period, the low level switch Yscl, falling ramp switch Yfr and ground switch Yg are turned on. Accordingly, the scan electrode (Y), low level switch Yscl, falling ramp switch (or falling ramp pulse switch) Yfr, scan voltage source Vscan, ground switch Yg are connected to the ground along a path \textcircled{4} in FIG. 4. In this time, in the current path, the scan voltage source Vscan is formed from a lower electrode toward an upper electrode, and the upper electrode of the scan voltage source Vscan is connected to the ground. Accordingly, the lower electrode of the scan voltage source Vscan has a negative voltage. As a result, the potential of the scan electrode (Y) is decreased to the negative scan voltage−V scan, according to the lower electrode of the scan voltage source Vscan from the ground based on the state that the falling ramp switch Yfr is turned on. Here, a path connected to the bias voltage source Vb is formed at the sustain electrode (X), thereby allowing the sustain electrode (X) to keep the bias voltage Vb.

Referring to FIGS. 3 and 5, wall charges are formed only at the scan electrode (Y) of the discharge cell that has been selected during the address period (AP), that is, T5 period and data is written.

During the T5 period, the low level switch Yscl and scan switch Ysc are turned on. Accordingly, along a path \textcircled{5} in FIG. 5, a current path is formed from the scan electrode (Y) through the low level switch Yscl, scan voltage source Vscan, ground switch Yg and ground. Accordingly, the potential of the scan electrode (Y) is decreased to the negative scan voltage−Vscan that corresponds to the potential of the lower electrode of the scan voltage source Vscan. In this time, a data signal is applied to the scan electrode (Y) from the address electrode and thus wall charge corresponding to the data signal is accumulated on the scan electrode (Y).

By contrast, in the scan electrode (Y) of the discharge cell that is not selected, the ground potential is maintained because the ground switch Yg is turned on. On the other hand, during the above period, the bias switch Xb is maintained to be turned on, thereby allowing the sustain electrode (X) to keep the bias voltage Vb.

Referring to FIGS. 3, 6 and 7, the sustain period (SP) is further divided into periods T6 to T13. During the sustain period (SP), wall charges accumulated on the scan and sustain electrodes (Y and X) perform display discharge.

During the T6 period, the energy supply switch Yr is turned on. Accordingly, a current path is formed from the inductive element L_{ERC} and capacitive element C_{ERC} through the energy supply switch Yr, body diode Qscl of the low level switch Yscl and scan electrode (Y) along a path \textcircled{6} in FIG. 6. Therefore, energy is transmitted from the energy recovery circuits (L_{ERC} and C_{ERC}) to the scan electrode (Y) and thus the voltage of the scan electrode (Y) is increased. On the other hand, during the T6 period, the ground switch Xg is turned on, thereby allowing the sustain electrode (X) to keep the ground voltage.

During the T7 period, the sustain switch Ys is turned on. Accordingly, a current path is formed through the sustain voltage source Vs, sustain switch Ys, body diode Qscl of the low level switch Yscl and scan electrode (Y) along a path \textcircled{7} in FIG. 6. Therefore, the scan electrode (Y) is connected to the sustain voltage source Vs and thus the voltage of the scan electrode (Y) is kept in the sustain voltage source Vs. On the other hand, during the T7 period, the ground switch Xg is turned on, thereby allowing the sustain electrode (X) to keep the ground voltage.

During the T8 period, the energy recovery switch Yf is turned on. Accordingly, a current path is formed through the scan electrode (Y), body diode Qsch of the high level switch Ysch, energy recovery switch Yf and energy recovery circuits (L_{ERC} and C_{ERC}) along a path \textcircled{8} in FIG. 6. Therefore, energy is transmitted from the scan electrode (Y) to the energy recovery circuits (L_{ERC} and C_{ERC}) and thus the potential of the scan electrode (Y) is decreased. In this time, the sustain electrode (X) is connected to the ground through the body diode Q_{G} of the ground switch Xg, thereby keeping the ground potential.

During the T9 period, the ground switch Yg is turned on. Accordingly, a current path is formed through the scan electrode (Y), body diode Qsch of the high level switch Ysch and energy recovery switch Yf along a path \textcircled{9} in FIG. 6. Therefore, the ground voltage is applied to the scan electrode (Y), and the voltage of the scan electrode (Y) is kept in the ground voltage. In addition, the T9 period may be continued for a certain time to provide margin before the voltage is applied to the sustain electrode (X). In this time, the sustain electrode (X) is kept in the ground potential by the body diode Q_{G} of the ground switch Xg similarly to the T8 period.

During the T10 period, the ground switch Yg is turned on. Accordingly, a current path is formed through the scan electrode (Y), body diode Qsch of the high level switch Ysch and ground switch Yg along a path \textcircled{10} in FIG. 7. Therefore, during the T10 period, the ground voltage is applied to the scan electrode (Y) and maintained similarly to the T9 period. On the other hand, the sustain electrode (X) is supplied with energy from the energy recovery circuit when the energy supply switch Xr is turned on, and the potential of the sustain electrode (X) is increased to the sustain voltage source Vs.

During the T11 period, the ground switch Yg is turned on. Accordingly, a current path is formed through the scan electrode (Y), body diode Qsch of the high level switch Ysch and ground switch Yg along a path \textcircled{11} in FIG. 7. Therefore, during the T11 period, the ground voltage is applied to the scan electrode (Y) and maintained similarly to the periods T9 and T10. On the other hand, the sustain switch Ys is turned on, thereby allowing the sustain electrode (X) to keep the sustain voltage source Vs.

During the T12 period, the ground switch Yg and high level switch Ysch are turned on. Accordingly, a current path is formed through the scan electrode (Y), high level switch Ysch, ground switch Yg and ground along a path \textcircled{12} in FIG. 7.

In addition, during the T12 period, the bypass switch Yop is also turned on. Accordingly, during the T12 period, a current path is formed through the scan electrode (Y), body diode Qscl of the high level switch Ysch, bypass switch Yop, ground switch Yg and ground along a path \textcircled{12} in FIG. 7. In addition, when the sustain current flows through the high level switch Ysch, the current is distributed by the bypass switch Yop. As a result, current flowing through switching transistors of the high level switch Ysch and low level switch Yscl is reduced because the main sustain current is distributed during the sustain period (SP) as described above. Thus, it is possible to reduce the temperature increase of the Scan IC during the T12 period.

On the other hand, during the T12 period, the energy recovery switch Xf is turned on. Accordingly, the voltage of the sustain electrode (X) is gradually decreased to the ground potential.

During the T13 period, the ground switch Yg, high level switch Ysch and bypass switch Yop are turned on. Accordingly, during the T13 period, a current path is formed through the scan electrode (Y), high level switch Ysch, ground switch Yg and ground and another current path is formed through the scan electrode (Y), body diode Qscl of the high level switch Ysch, bypass switch Yop, ground switch Yg and ground along a path \textcircled{13} in FIG. 7 similarly to the T12 period. As a result, the scan electrode (Y) keeps the ground potential.

On the other hand, during the T13 period, the ground switch Xg is turned on, thereby allowing the sustain electrode (X) to keep the ground potential. In addition, the T13 period may be maintained for a certain time.

As described above, in the driving circuit of the plasma display device, most of the sustain current flowing through the scan electrode (Y) during the sustain period (SP) flows through the body diode Qsch of the high level switch or the body diode Qscl of the low level switch. In addition, the current flowing through the high level switch Ysch is reduced by additionally forming the bypass current path through the bypass switch Yop even when the sustain current flows through the high level switch Ysch. Thus, the driving circuit can reduce the temperature increase of the Scan IC that has been caused by the current channeling to the low level switch Yscl in the conventional device. In addition, the manufacturing process is simplified and manufacturing costs are reduced because the internal potentials of the high level switch Ysch and low level switch Yscl are maintained the same to each other.

A construction of a plasma display device according to another embodiment of the present invention will be explained below.

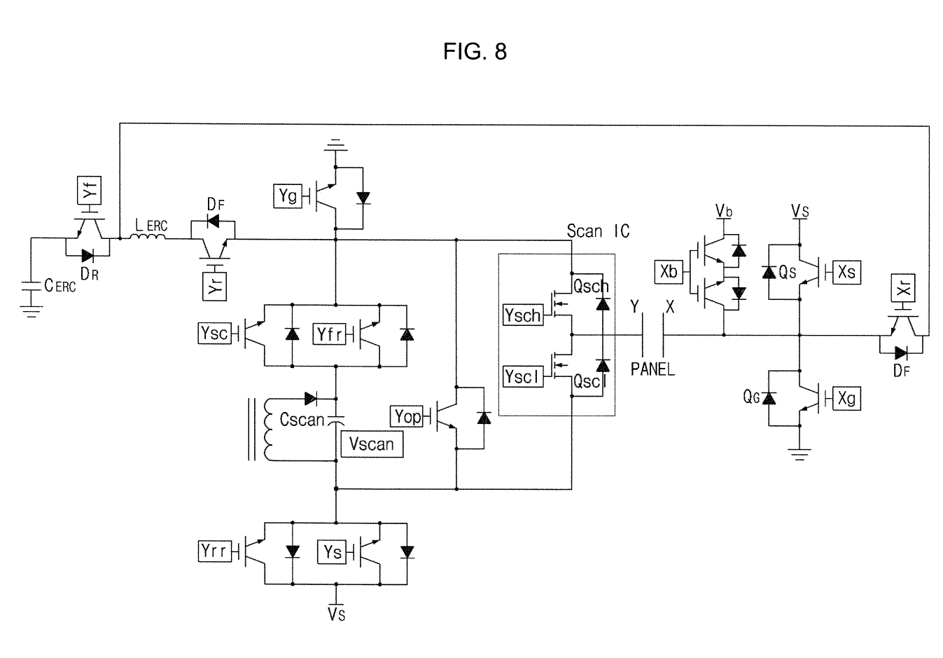

FIG. 8 shows a driving circuit of the plasma display device according to the another exemplary embodiment. The same drawing reference numerals are used for the same elements in the drawing. Differences from the above embodiment will be mainly explained below.

Referring to FIG. 8, the driving circuit used in the plasma display device is different from the previous embodiment in the structure of an energy recovery circuit connected to scan and sustain electrodes (Y and X).

The energy recovery circuit uses a capacitive element C_{ERC} commonly connected with the scan and sustain electrodes (Y and X).

Accordingly, in the driving circuit, an energy recovery path of the scan electrode (Y) is constructed in a back-to-back structure. In other words, an energy supply switch Yr and an energy recovery diode D_{F} of the energy recovery circuit are connected in parallel to each other. An energy recovery switch Yf and an energy supply diode D_{R} are connected in parallel to each other. In addition, the energy supply switch Yr and energy recovery diode D_{F} are serially connected to the energy recovery switch Yf and energy supply diode D_{R}. The energy recovery circuit is shown to be connected to the high level switch Ysch of the Scan IC but may be connected to the low level switch Yscl.

Also, in the energy recovery circuit of the sustain electrode (X), the inductive element L_{ERC} and energy recovery switch Xf are removed, and the energy supply switch Xr and energy recovery diode D_{F} are connected in parallel to each other so as to be symmetrical to the above construction.

In addition, the energy supply switch Xr of the sustain electrode (X) is serially connected to a wire connected between the inductive element L_{ERC} and capacitive element C_{ERC} of the scan electrode (Y). In other words, the energy recovery circuits of the scan and sustain electrode (Y and X) are harness-connected to each other through the wire. Here, the wire connects the energy recovery circuits to allow the scan and sustain electrode (Y and X) to commonly use the capacitive element C_{ERC} and in addition, operates as the inductive element of the sustain electrode (X) due to its own inductance.

As described above, in the plasma display device, the capacitive element C_{ERC} can be commonly used by connecting the energy recovery circuits of the scan and sustain electrode (Y and X) in the back-to-back form (type) and harness-connecting them to each other. Thus, the manufacturing costs of the plasma display device can be reduced.

A construction of a plasma display device according to a another embodiment of the present invention will be explained below.

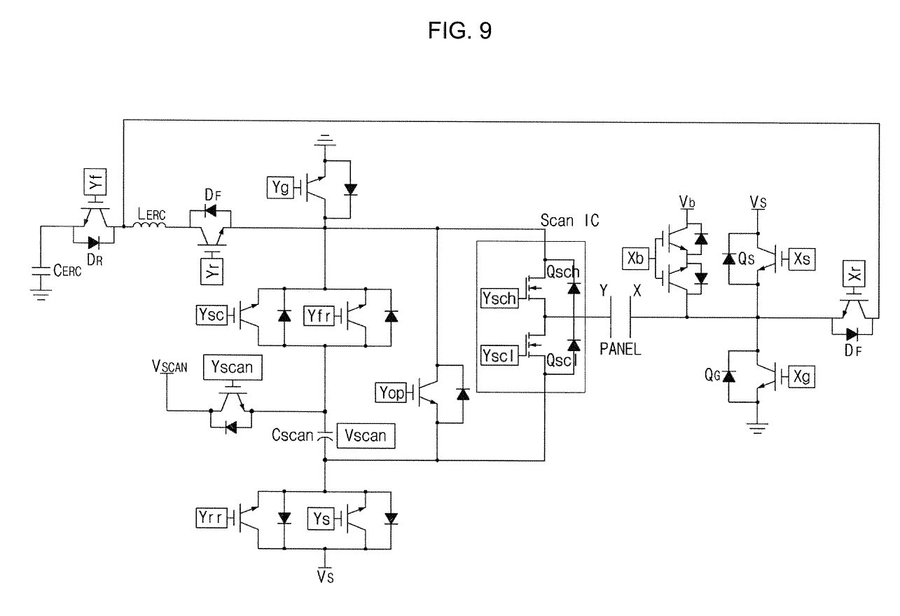

FIG. 9 shows a driving circuit of the plasma display device according to the still another exemplary embodiment.

Referring to FIG. 9, the driving circuit of the plasma display device is different from the above embodiment in the construction of a scan voltage source Vscan.

The scan voltage source Vscan includes a capacitive element Cscan serially connected between a scan switch Ysc and a sustain switch Ys and an external voltage source connected to an upper electrode of the capacitive element Cscan through a switch Yscan.

The switch Yscan of the scan voltage source Vscan is turned on only when both of ground switch Yg and bypass switch Yop are turned on. Accordingly, the scan voltage Vscan of the external voltage source is applied to the upper electrode of the capacitive element Cscan only when the ground voltage is applied to the lower electrode of the capacitive element Cscan through the ground switch Yg and bypass switch Yop.

The plasma display device can be stably supplied with the scan voltage Vscan from the external voltage source and simply constructed as compared to the case where the DC-DC converter is used. Thus, the manufacturing costs of the plasma display device can be further reduced.

A construction of a plasma display device according to another embodiment of the present invention will be explained below.

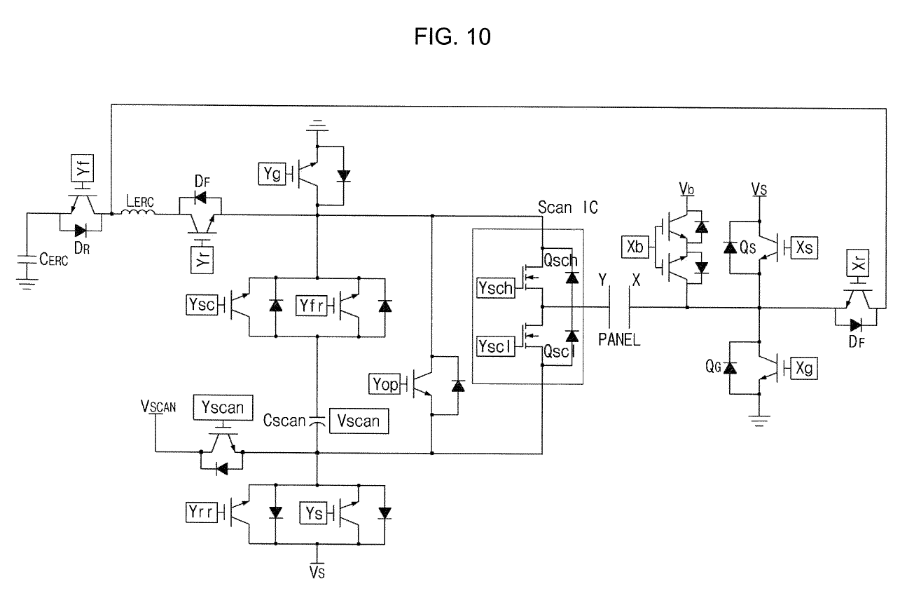

FIG. 10 shows a driving circuit of the plasma display device according to the another exemplary embodiment.

Referring to FIG. 10, the driving circuit of the plasma display device is different from the above embodiment only in the construction of a scan voltage source Vscan.

The scan voltage source Vscan includes a capacitive element Cscan serially connected between a scan switch Ysc and a sustain switch Ys and an external voltage source electrically coupled to an upper electrode of the capacitive element Cscan through a switch Yscan.

The switch Yscan of the scan voltage source Vscan is turned on only when both of ground switch Yg and scan switch Ysc are turned on. In other words, the scan voltage Vscan of the external voltage source is applied to the lower electrode of the capacitive element Cscan only when the ground voltage is applied to the upper electrode of the capacitive element Cscan through the ground switch Yg and scan switch Ysc.

The plasma display device can be continuously supplied with the scan voltage from the external voltage source Vscan during the address period (AP). Thus, the plasma display device can more stably perform data writing during the address period (AP).

As described above, the plasma display device and the driving method thereof according to embodiments of the present invention produce the following effects.

First, the sustain current flows through the body diode of the switch transistor of the scan IC during the sustain period, thereby reducing the internal potential and temperature of the scan IC.

Second, the pass switch connected to the conventional main current path is removed and the conventional high level voltage source is substituted by the ground, thereby reducing the manufacturing costs.

Third, the inductance or resistance on the circuit is reduced (or minimized) by arranging the scan electrode at the position nearest from the scan IC, thereby improving efficiency and safety.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display device including a scan electrode and a sustain electrode, comprising:
a scan integrated circuit (IC) electrically coupled to the scan electrode;
a first switch electrically coupled between the scan IC and a first voltage source;
a second switching switch electrically coupled between the scan IC and a second voltage source;
a third voltage source electrically coupled between the first and second switches to supply a third voltage; and
a third switch electrically and serially coupled to the third voltage source between the first and second switches.

2. The plasma display device of claim 1, wherein the first voltage source is the ground.

3. The plasma display device of claim 1, wherein the third voltage source is a direct current (DC) voltage source.

4. The plasma display device of claim 1, wherein the third voltage source comprises a capacitive element electrically coupled between the first and second switches and a DC-DC converter electrically coupled to both ends of the capacitive element.

5. The plasma display device of claim 1, wherein the third voltage source comprises:
a capacitive element electrically coupled between the first and second switches;
a DC voltage source electrically coupled to one end of the capacitive element; and
a fourth switch electrically coupled between the capacitive element and the DC voltage source.

6. The plasma display device of claim 1, further comprising an energy recovery unit electrically coupled to a contact point between the first switch or the second switch and the scan IC, wherein the energy recovery unit comprises an inductive element and a capacitive element electrically coupled between the inductive element and the ground.

7. The plasma display device of claim 6, further comprising a fifth switch electrically coupled between the inductive element and the capacitive element.

8. The plasma display device of claim 6, further comprising a harness wire, wherein one end of the harness wire is electrically coupled between the inductive element and the capacitive element and the other end of the harness wire is electrically coupled to the sustain electrode.

9. The plasma display device of claim 6, wherein the inductive element and the capacitive element of the energy recovery unit are connected to each other in a back-to-back form.

10. The plasma display device of claim 1, wherein the scan IC comprises:
a high level switch electrically coupled between the scan electrode and the first switch; and
a low level switch electrically coupled between the scan electrode and the second switch.

11. The plasma display device of claim 10, wherein the high and low level switches are turned off while a positive voltage is applied to the scan electrode during a sustain period of the plasma display device, thereby allowing sustain current to flow through a body diode of the high level switch or the low level switch.

12. The plasma display device of claim 10, wherein the high and low level switches are turned off while a rising waveform of the plasma display device or the voltage of the second voltage source is applied to the sustain electrode during a sustain period of the plasma display device, thereby allowing sustain current to flow through a body diode of the high level switch or the low level switch.

13. The plasma display device of claim 10, wherein the high level switch is turned on and the low level switch is turned off while a falling waveform of the plasma display device is applied to the scan electrode during a sustain period of the plasma display device, thereby allowing sustain current to flow through the high level switch.

14. The plasma display device of claim 10, further comprising a sixth switch electrically coupled in parallel to both ends of the scan IC.

15. The plasma display device of claim 14, wherein the sixth switch is turned on and the low level switch is turned off while a falling waveform of the plasma display device is applied to the scan electrode during a sustain period of the plasma display device, thereby allowing sustain current to be distributed and flow through a body diode of the low level switch.

16. A method of driving a plasma display device including a scan electrode and a sustain electrode, the method comprising:
applying a rising waveform to the scan electrode by turning on a fourth switch to allow sustain current to flow from an energy recovery unit through a body diode of a low level switch during a sustain period; and
applying a second voltage to the scan electrode by turning on a second switch to allow the sustain current to flow from a second voltage source through a body diode of a high level switch during the sustain period,
wherein the plasma display device comprises: a scan integrated circuit (IC) electrically coupled to the scan electrode; a first switch electrically coupled between the scan IC and a first voltage source; the second switch electrically coupled between the scan IC and the second voltage source; a third switch between the first switch and the energy recovery unit; the fourth switch between the second switch and the energy recovery unit, and wherein the scan IC comprises the high level switch electrically coupled between the scan electrode and the first switch and the low level switch electrically coupled between the scan electrode and the second switch.

17. The method of claim 16, further comprising:
applying a falling waveform to the scan electrode by turning on the third switch to allow the sustain current to flow through the body diode of the high level switch; and
applying a first voltage to the scan electrode by turning on the first switch to allow the sustain current to flow through the body diode of the high level switch after the applying of the second voltage to the scan electrode.

18. The method of claim 16, wherein the first voltage source supplies the ground voltage.

19. The method of claim 16, wherein the second voltage source supplies a sustain voltage.

20. The method of claim 16, wherein the energy recovery unit comprises an inductive element electrically coupled to the third switch and a capacitive element electrically coupled to the inductive element, and wherein the energy recovery unit is electrically coupled to the sustain electrode through a harness wire electrically coupled between the inductive element and capacitive element, thereby charging and discharging energy applied to the scan and sustain electrodes.
